(19) United States
(12) Patent Application Publication
(10) Pub. No.: US 2013/0233984 A1
(43) Pub. Date: Sep. 12, 2013

(54) HEIGHT-ADJUSTABLE STAND

(71) Applicant: HSIEN-HUEI HUANG, NEW TAIPEI CITY (TW)

(72) Inventor: HSIEN-HUEI HUANG, NEW TAIPEI CITY (TW)

(73) Assignee: SYNCMOLD ENTERPRISE CORP., NEW TAIPEI CITY (TW)

(21) Appl. No.: 13/492,860

(22) Filed: Jun. 9, 2012

(30) Foreign Application Priority Data
Mar. 7, 2012 (TW) 101204122

(51) Int. Cl. F16M 11/28

(52) U.S. Cl. 248/162.1

(57) ABSTRACT

The instant disclosure relates to a height-adjustable stand for supporting and controlling the position of a monitor. The stand is for disposing on a working surface and includes a base, a slidable frame, a plurality of springs, and a plurality of force members corresponding to the springs. The base is disposed on the working surface, and the frame is slidably disposed on the base. One end of each spring is fixed to the base, and each force member is connected to the corresponding spring and selectively engaged to the frame. When the frame slides with respect to the base, the engaged force member moves with the frame. The displacement of the force member allows the corresponding spring to create a counter force for maintaining the frame at any position between a first position and a second position.

### BACKGROUND OF THE INVENTION

1. Field of the Invention

The instant disclosure relates to a height-adjustable stand; more particularly, to a height-adjustable stand adaptable to a screen/monitor.

2. Description of Related Art

A screen/monitor typically is incapable of standing stably by itself on a mounting surface. A support stand mounted to the rear portion of the screen/monitor is required to arrange the screen/monitor stably on the mounting surface, such as the surface of a table. One type of the abovementioned support stand is a height-adjustable stand, as described in a Taiwan patent (Pat. No. M311200, Pat. Appl. No. 095218265).

However, existing stands such as the one mentioned hereinabove is compatible with only a particular sized monitor having a certain weight. Accordingly, for various sized monitors on the market, the manufacturers must provide different sized support stands. Much manufacturing cost is thus wasted.

In addition, while storing or transporting the existing support stands, the height of the support stands must be minimized, such that the support stands would occupy least amount of space. This procedure keeps the spring member often found in the support stands at a stressed state, which may result in elastic fatigue.

### SUMMARY OF THE INVENTION

The object of the instant disclosure is to provide a height-adjustable stand adaptable to a screen/monitor. The stand of the instant disclosure can prevent the occurrence of elastic fatigue to the spring and is adaptable to different sized monitors/screens.

For disposing on a working surface, the stand of the instant disclosure comprises: a base disposed on the working surface; a frame slidably disposed on the base; a plurality of springs, where one end of each spring is fixed to the base; and a plurality of force members corresponding to respective springs, where each force member is capable of engaging independently and selectively to the frame and the respective spring. When the frame rides along the base, the force members are urged into a sliding motion. Accordingly, a counter force is generated by the corresponding springs. The frame may be maintained at any position between a first position and a second position.

Preferably, at least one of the force members is forced to move by the frame.

Preferably, the base includes a support and a stopping member. The frame is slidably disposed on the support, while the stopping member is fixedly mounted on the support. The stopping member is capable of blocking the force members.

Preferably, the aforementioned springs are constant-force springs. Each of the constant-force springs has a rolled portion and a tip portion. The rolled portion of each constant-force spring is received by the corresponding force member. The tip portion of each constant-force spring is fixed to the base.

Preferably, each of the force members has a main portion defining a receiving structure. The rolled portion of each constant-force spring is accommodated by the receiving structure of the corresponding force member.

Preferably, when the constant-force spring is at its natural position, the corresponding force member is abutted by the stopping member. Each force member defines a retaining hole through which a corresponding retaining member of the stopping member is led.

Preferably, the springs are tension springs. Each of the tension springs has a main body, where a pair of raised hooks is formed on opposite ends of the main body. The respective raised hooks of each tension spring are fixedly mounted to the corresponding force member and the stopping member.

Preferably, the stopping member has a plurality of arms. Each force member has a main portion defining a receiving structure. The respective raised hooks of each tension spring are fixed to the receiving structure of the corresponding force member and the corresponding arm of the stopping member.

Preferably, the support defines a plurality of elongated guide slots extending parallely to the stretching direction of the tension springs. The main portion of each force member is fitted with a coupler, where the main portion and the corresponding coupler are movably disposed on the support and capable of riding along the guide slots.

Preferably, each of the force members includes a locking stud connected to the frame.

Based on the foregoing, the height-adjustable stand provided by the instant disclosure utilizes the force members and the frame to prevent elastic fatigue during product storage or transportation. The stand itself is also adaptable to monitors/displays having different sizes.

### BRIEF DESCRIPTION OF THE DRAWINGS

FIG. 1 is a perspective view of a height-adjustable stand without a locking stud for a first embodiment of the instant disclosure.

FIG. 2 is an exploded view of the stand in FIG. 1.

FIG. 3 is a cross-sectional side view of the stand in FIG. 1.

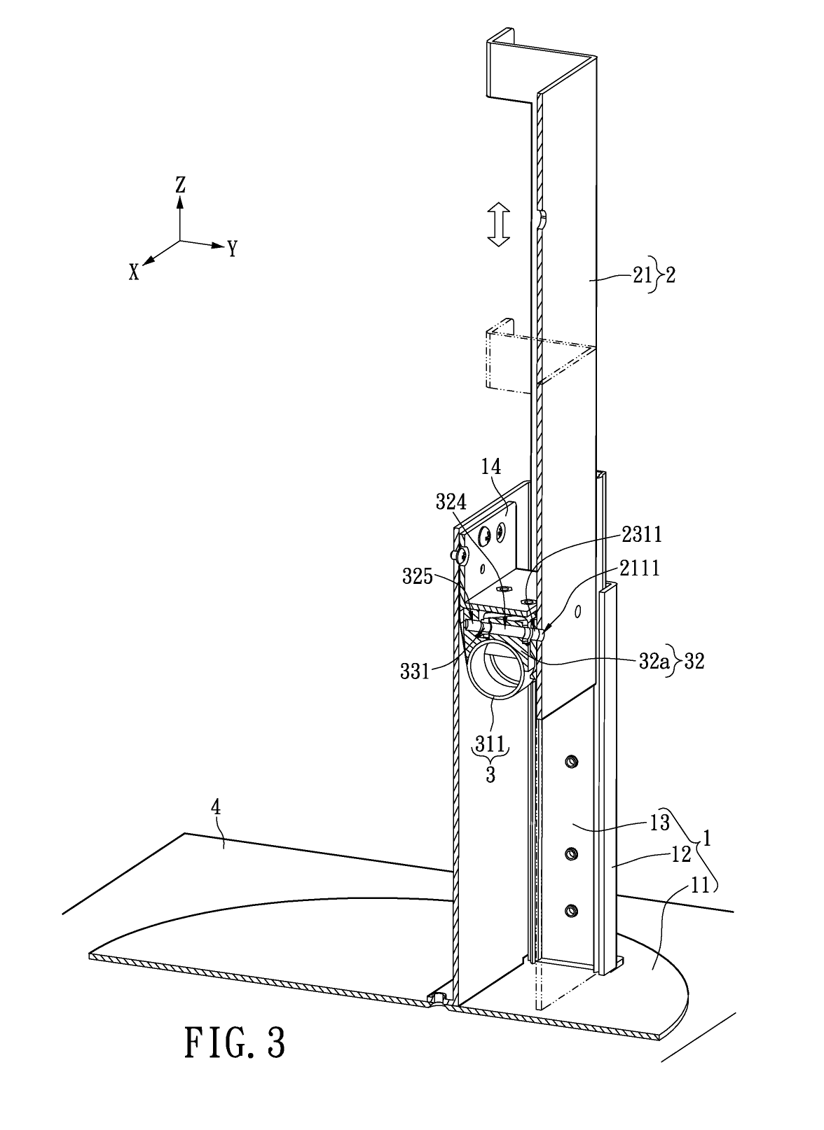

FIG. 4 is a perspective view of the stand in FIG. 1 fitted with the locking studs, where a frame is at a highest position.

FIG. 5 is a cross-sectional side view of the stand in FIG. 4.

FIG. 5A is a partial enlarged view of FIG. 5.

FIG. 6 is a perspective view of the stand in FIG. 4 with the frame being at the lowest position.

FIG. 7 is a cross-sectional side view of the stand in FIG. 6.

FIG. 8 is a perspective view of a stand without the locking stud for a second embodiment of the instant disclosure.

FIG. 9 is an exploded view of the stand in FIG. 8.

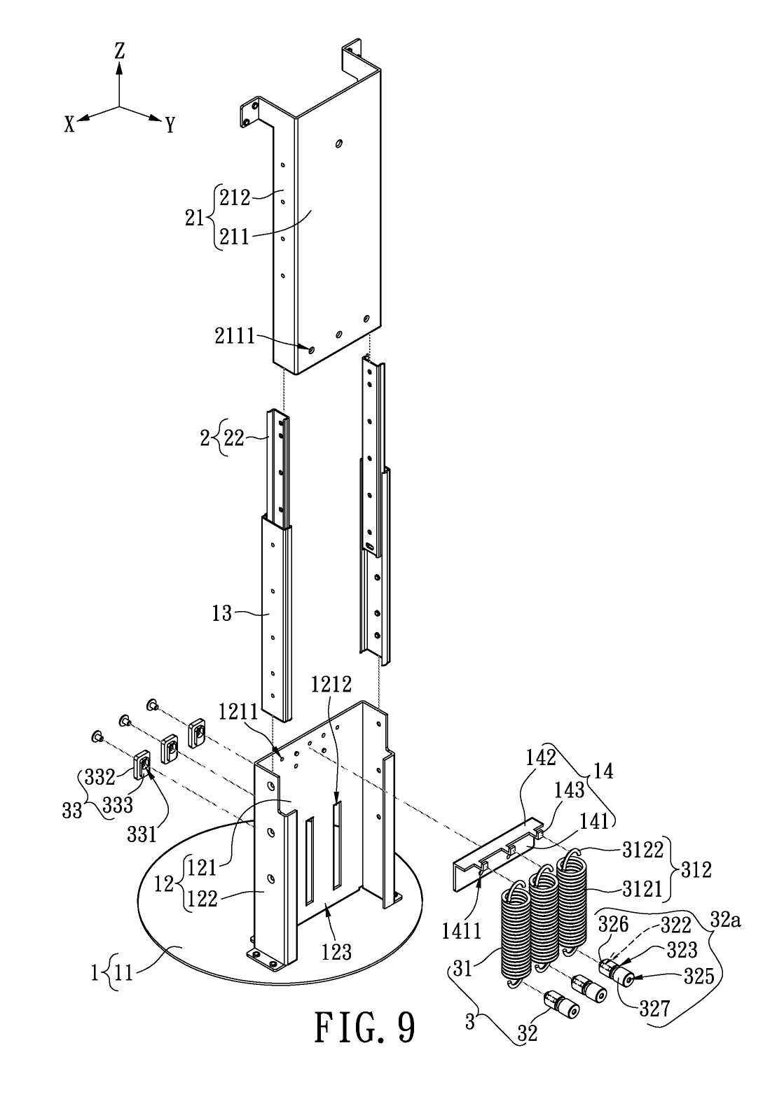

FIG. 10 is a cross-sectional side view of the stand in FIG. 8.

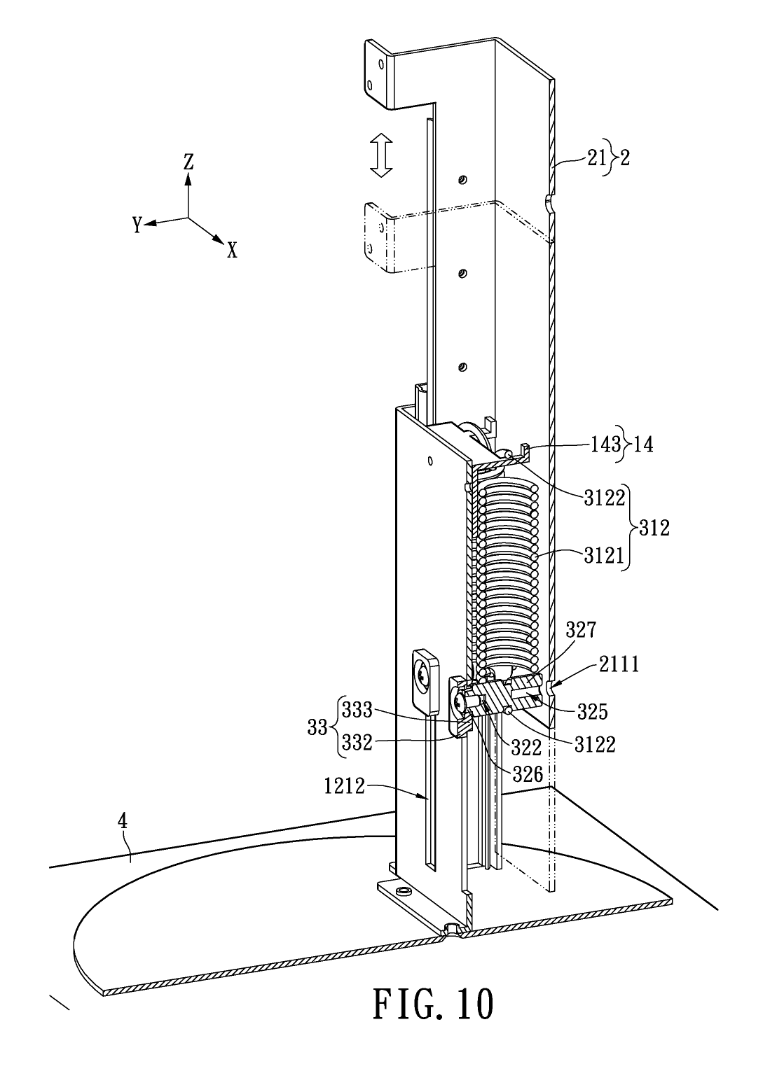

FIG. 11 is a perspective view of the stand in FIG. 8 fitted with the locking studs, where the frame is arranged at the highest position.

FIG. 12 is a cross-sectional side view of the stand in FIG. 11.

FIG. 13 is a perspective view of the stand in FIG. 11 with the frame being arranged at the lowest position.

FIG. 14 is a cross-sectional side view of the stand in FIG. 13.

### DETAILED DESCRIPTION OF THE EMBODIMENTS

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### First Embodiment

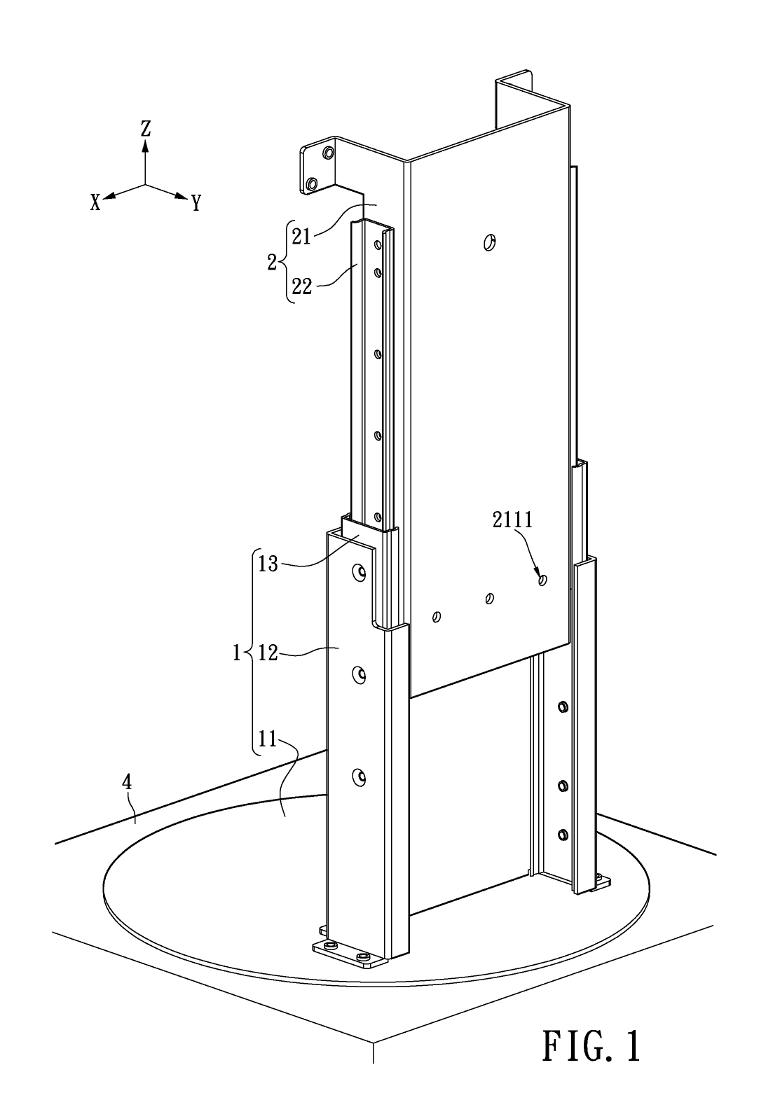

Please refer to FIGS. 1˜3, where a height-adjustable stand is provided by the instant disclosure for disposing on a working surface 4 (e.g., a tabletop). The stand comprises a base 1, a sliding mechanism 2, and a plurality counter force-generating mechanisms 3. For this particular embodiment, three counter force-generating mechanisms 3 are employed.

In certain condition, all of the counter force-generating mechanisms 3 are engaged to the sliding mechanism 2 and capable in being displaced. In other cases, none of the counter force-generating mechanisms 3 are engaged to the sliding mechanism 2. For still other conditions, some of the counter force-generating mechanisms 3 are engaged to the sliding mechanism 2, while the remaining counter force-generating mechanisms 3 are not engaged to the sliding mechanism 2.

The sliding mechanism 2 is slidable with respect to the base 1 along a first direction Z (i.e.: perpendicular to the working surface 4 and directed upwardly). The sliding capability allows the sliding mechanism 2 to be selectively disposed at any position between a first position and a second position. The first position is defined as the highest position, where the sliding mechanism 2 is farthest away from the working surface 4. Whereas the second position is defined as the lowest position, where the sliding mechanism 2 is closest to the working surface 4.

The description that follows immediately is for the case where none of the counter force-generating mechanisms 3 are engaged to the sliding mechanism 2, while the sliding mechanism 2 is disposed at the highest position.

The base 1 includes a base plate 11, a support 12, a pair of tracks 13, a stopping member 14, and three pairs of retaining members 15. The base plate 11 is arranged on the working surface 4 and circular shaped. However, the exact shape of the base plate 11 is not restricted thereto. The support 12 has a main plate 121 and a pair of sidewalls 122 normally extended from opposite sides thereof. The main plate 121 and the sidewalls 122 are rectangular shaped and cooperatively define a receiving space 123.

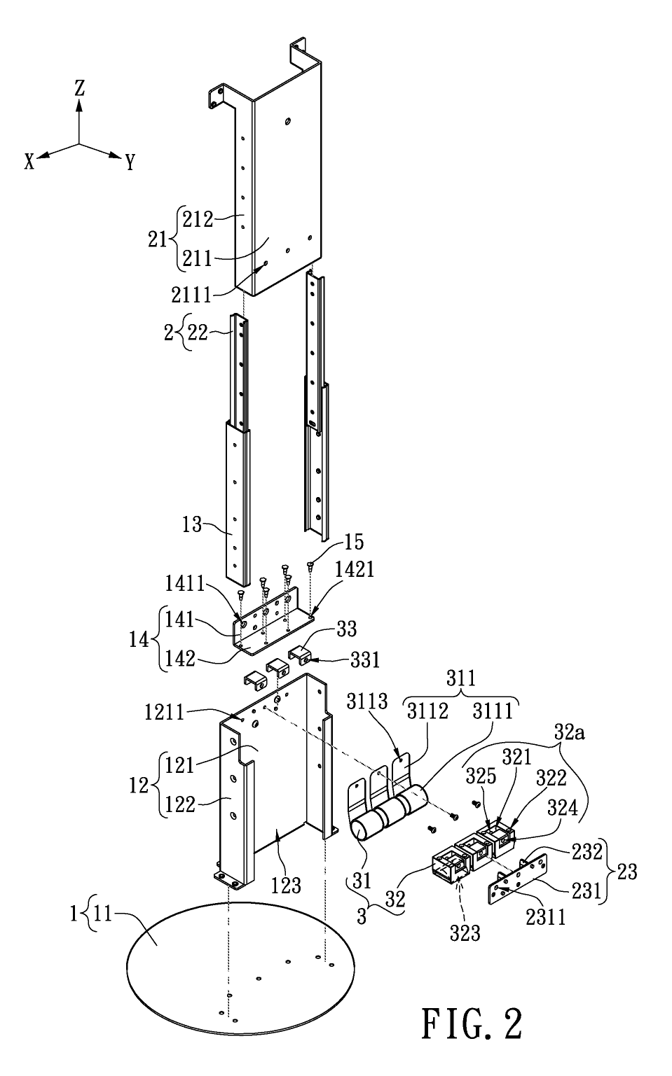

The long axis of each sidewall 122 is directed toward the first direction Z. A second direction Y is defined to be normal to the main plate 121 and the first direction Z and directed rightward in FIG. 2. Whereas a third direction X is defined to be normal to the first and second directions Z, Y and directed leftward in FIG. 2. However, the first, second, and third directions X, Y, and Z may be changed arbitrarily by the designer and are not restricted to the perpendicular relationship of the exemplary embodiment.

For the orientation shown in FIG. 2, the top portion of the main plate 121 defines three fastening holes 1211. The main plate 121 and the sidewalls 122 are fixed to the base plate 11. Each of the tracks 13 is strip-shaped with its long axis parallel to the first direction Z. The tracks 13 are fixed to the respective sidewalls 122 and face toward one another.

The stopping member 14 is accommodated in the receiving space 123 and has an L-shaped cross-section. Structurally, the stopping member 14 has a rest plate 141 and a stop plate 142 extending normally therefrom.

The long axes of the rest plate 141 and the stop plate 142 are parallel to the third direction X. The rest plate 141 further has three via holes 1411, and the stop plate 142 defines three pairs of through holes 1421.

To anchor the stopping member 14 to the main plate 121 of the support 12, screws (not labeled) are passed through the via holes 1411 of the rest plate 141 and the fastening holes 1211 of the support 12.

The retaining members 15 are penetrated through the through holes 1421 of the stop plate 142 in parallel to the first direction Z and fixed to the stop plate 142. The protruded portion of each retaining member 15 passing through the stop plate 142 is directed away from the rest plate 141.

The sliding mechanism 2 includes a frame 21, a pair of slide bars 22, and a divider 23. The frame 21 has a substantially plate shaped central body 211 and a pair of side plates 212 extending normally from opposite sides thereof. The long axes of the central body 211 and the side plates 212 are parallel to the first direction Z. For the orientation shown in FIG. 2, the bottom portion of the central body 211 defines three penetrating holes 2111.

A monitor (not shown) may be mounted on the frame 21, where the mounting method is not restricted. For example, the monitor may be mounted directly or indirectly to the frame 21 per user's preference.

Each of the slide bars 22 is strip-shaped and its long axis is parallel to the first direction Z. The slide bars 22 are fixed on the outer surfaces of the respective side plates 212 facing away from each other.

The divider 23 is disposed in a region defined by the central body 211 and the side plates 212. The divider 23 has a fixing plate 231 and a pair of partition walls 232 extending therefrom pararllely to the second direction Y.

The fixing plate 231 is substantially rectangular shaped and its long axis is parallel to the third direction X, and the fixing plate 231 has three securing holes 2311.

One side of the fixing plate 231 is secured to the inner surface of the central body 211 of the frame 21. The securing holes 2311 of the fixing plate 231 correspond to the penetrating holes 2111 of the frame 21.

The interconnection between the base 1 and the sliding mechanism 2 is described herein. The slide bars 22 are movably disposed on the respective tracks 13, where the slider bars 22 are operable synchronously. The slide bars 22 allow the frame 21 and the divider 23 to be movably received in the receiving space 123. In other words, the slide bars 22 may ride along the tracks 13 in a direction parallel to the first direction Z.

Each counter force-generating mechanism 3 includes a spring 31, a force member 32, and a coupler 33. Since all of the counter force-generating mechanisms 3 are the same, one of the counter force-generating mechanisms 3 is used as an example for explaining its structural characteristics and operating method hereinbelow.

For the instant embodiment, the spring 31 is a constant-force spring 311. The constant-force spring 311 is disposed in the receiving space 123, where the constant-force spring 311 has a rolled portion 3111 and a tip portion 3112. For the orientation shown in FIG. 2, the upper region of the tip portion 3112 defines a mounting hole 3113.

The rolled portion 3111 is arranged between the stop plate 142 and the base plate 11, while the tip portion 3112 is secured in between the main plate 121 of the support 12 and the rest plate 141 of the stopping member 14. A screw (not labeled) is passed through the corresponding via hole 1411 of the rest plate 141, the mounting hole 3113 of the tip portion 3112, and the corresponding fastening hole 1211 of the main plate 121 in sequence to secure the tip portion 3112 of the constant-force spring 311 on the support 12.

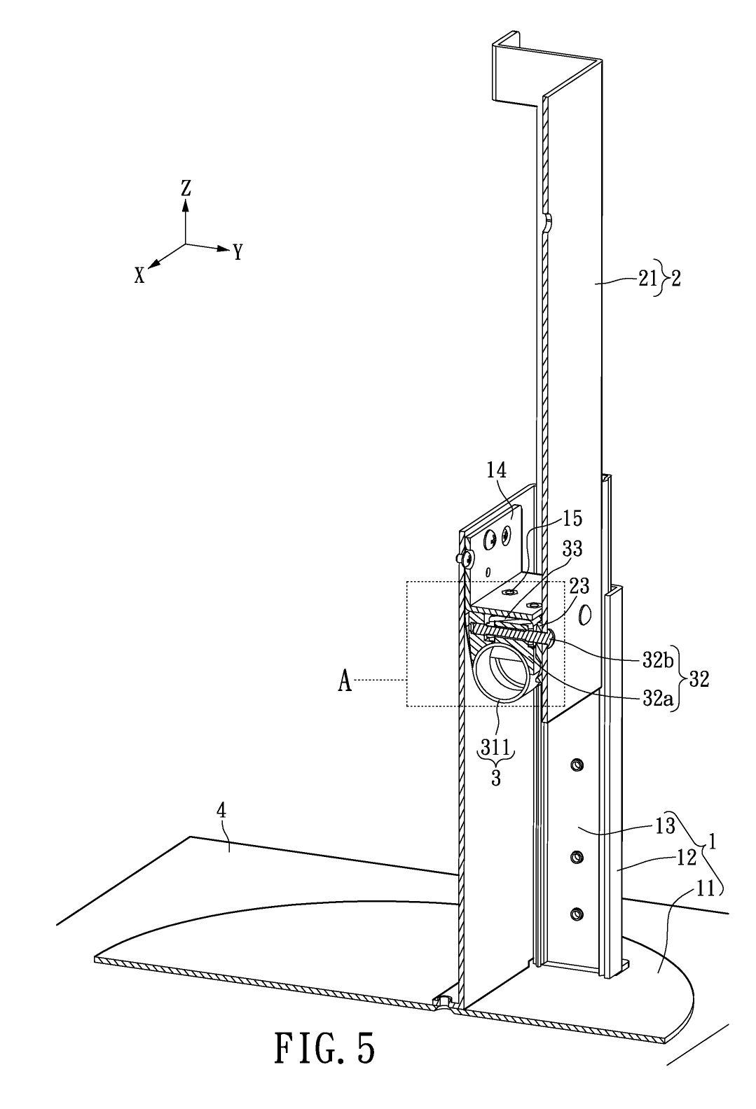

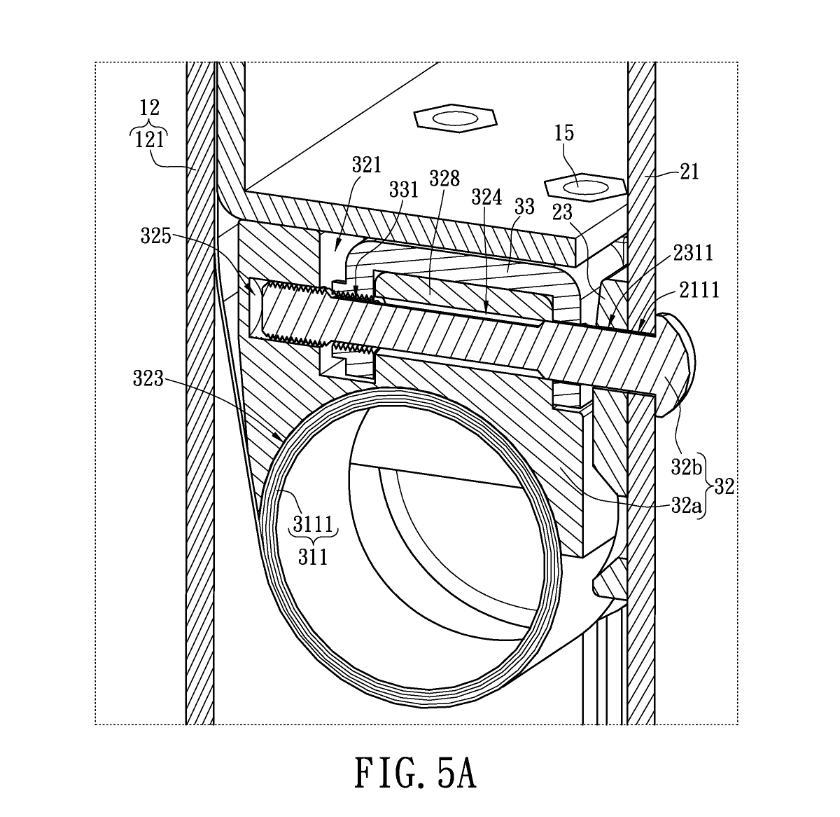

Please refer to FIG. 5A in conjunction with FIGS. 1˜3. The abovementioned force member 32 has a main portion 32a that is substantially cubic shaped. The main portion 32a defines a reversed U-shaped slot 321 on the upper portion thereof and a pair of retaining holes 322 close to the U-shaped slot 321. Whereas the bottom region of the main portion 32a defines a circular receiving structure 323. The main portion 32a further has a ridge 328 cooperatively defined by the U-shaped slot 321.

The constant-force spring 311 is fitted to the main portion 32a of the force member 32. Namely, the rolled portion 3111 of the constant-force spring 311 is received by the receiving structure 323 of the force member 32. The corresponding retaining member 15 is passed through the retaining hole 322 of the main portion 32a.

It is worth noting the main portions 32a are separated from each other by the corresponding partition wall 232 of the divider 23. While the main portion 32a holds the corresponding constant-force spring 311, the partition wall 232 prevents the main portion 32a from tilting. If the main portion 32a is tilted, the corresponding operation of the constant-force spring 311 is adversely affected.

The coupler 33 is a U-shaped plate member. The coupler 33 is received by the U-shaped slot 321 and caps the ridge 328. Furthermore, the coupler 33 does not protrude from the main portion 32a.

More specifically, the opposite side portions of the coupler 33 cover the respective faces of the ridge 328. The opposite side portions of the coupler 33 further define a pair of side holes 331, and the ridge 328 defines a center hole 324. The side holes 331 and the center hole 324 correspond to the respective securing hole 2311 of the divider 23 and are parallel to the second direction Y. The uncapped region of the main portion 32a defines a blind hole 325, where the blind hole 325 is in axial alignment with the side holes 331 and the center hole 324.

Based on the above, for the first embodiment shown in FIGS. 1˜3, the counter force-generating mechanisms 3 are not connected to the sliding mechanism 2. In other words, the constant-force springs 311 of the counter force-generating mechanisms 3 do not carry the sliding mechanism 2 and the mounted monitor.

Thereby, when the frame 21 of the sliding mechanism 2 is being adjusted from the highest to lowest position, the counter force-generating mechanisms 3 remain idle. In other words, the distance between the counter force-generating mechanisms 3 and the working surface 4 remains substantially the same.

Thus, when the stand is being stored or transported, the frame 21 of the sliding mechanism 2 may be adjusted to the lowest position to minimize the space occupied by the stand. The constant-force springs 311 of the counter force-generating mechanisms 3 remain unstretched. Accordingly, the issue of elastic fatigue can be prevented. However, during the transporting process, to keep the frame 21 of the sliding mechanism 2 from sliding aimlessly, styrofoam is typically used to package the frame 21 to restrict its movement.

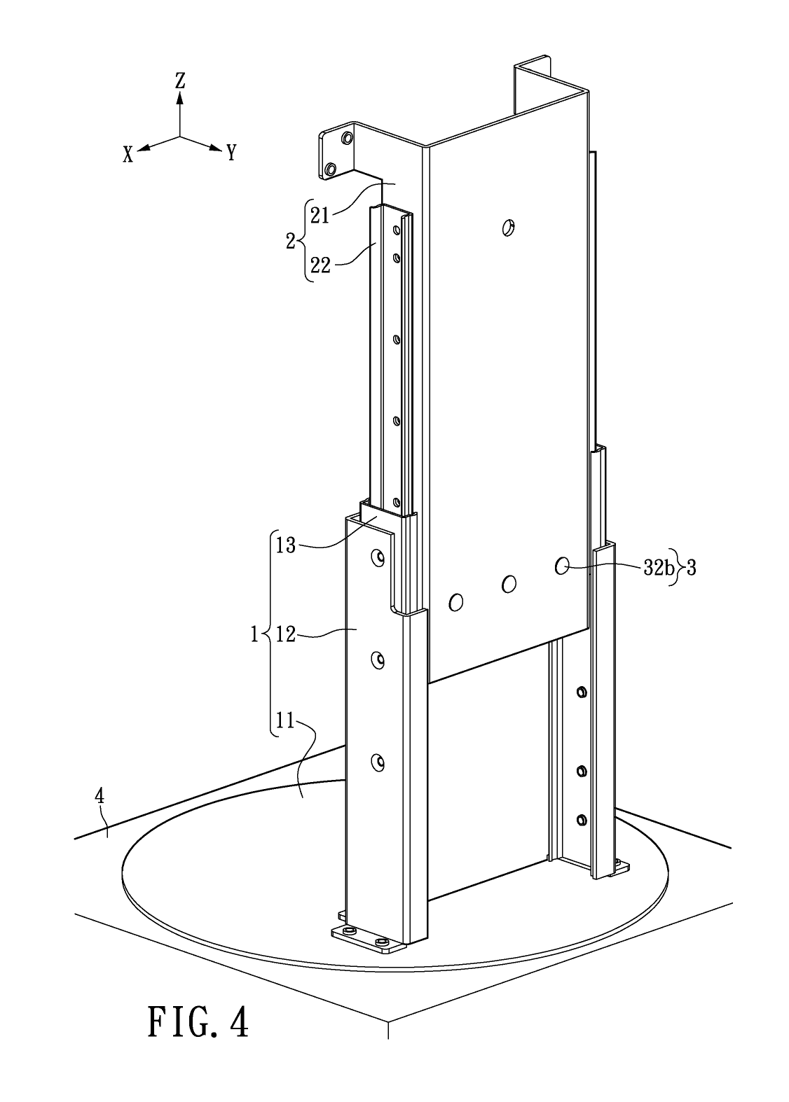

Now refer to FIGS. 4, 5, and 5A, which illustrate each of the counter force-generating mechanisms 3 are engaged to the sliding mechanism 2. The description provided hereinbelow relates to the frame 21 of the sliding mechanism 2 oriented at the highest position.

Each of the force members 32 further includes a locking stud 32b (i.e.: an inserted shaft). For the instant embodiment, a screw is utilized as the locking stud 32b. The locking stud 32b is oriented in a direction parallel to the second direction Y. Moreover, the locking stud 32b passes through the penetrating hole 2111 of the frame 21, the securing hole 2311 of the divider 23, the side holes 331 of the coupler 33, the center hole 324 of the ridge 328 in sequence and is partially received in the blind hole 325 of the main portion 32a.

For the coupler 33, one of the side holes 331 that is arranged in close to the blind hole 325 is threaded. Correspondingly, the locking stud 32b has a threaded portion that is threadably engageable with the threaded side hole 331. The diameter of the blind hole 325 is slightly less than that of the threaded portion of the locking stud 32. Thus, when the threaded portion of the locking stud 32 is passed through the coupler 33 and driven into the blind hole 325, a tight fit is provided between the locking stud 32b and the main portion 32a. The tightness alarms the user that the locking stud 32b has already penetrated the coupler 33 and into the blind hole 325.

Besides using the screw, other types of design may be applied to the locking stud 32b. For example, the locking stud 32b may take the form of a button (not shown). With the button-like configuration, the user can press the locking stud 32b to engage/disengage the corresponding counter force-generating mechanisms 3 to/from the sliding mechanism 2. Alternatively, the force member 32 and the coupler 33 may be replaced by the locking stud 32b alone to interact with the constant-force spring 311 and a similar effect would be achieved.

In other words, the counter force-generating mechanism 3 may utilize the locking stud 32b for connecting to the sliding mechanism 2. Thus, the loads caused by the sliding mechanism 2 and its supported article (e.g., monitor) are transferred to the constant-force springs 311.

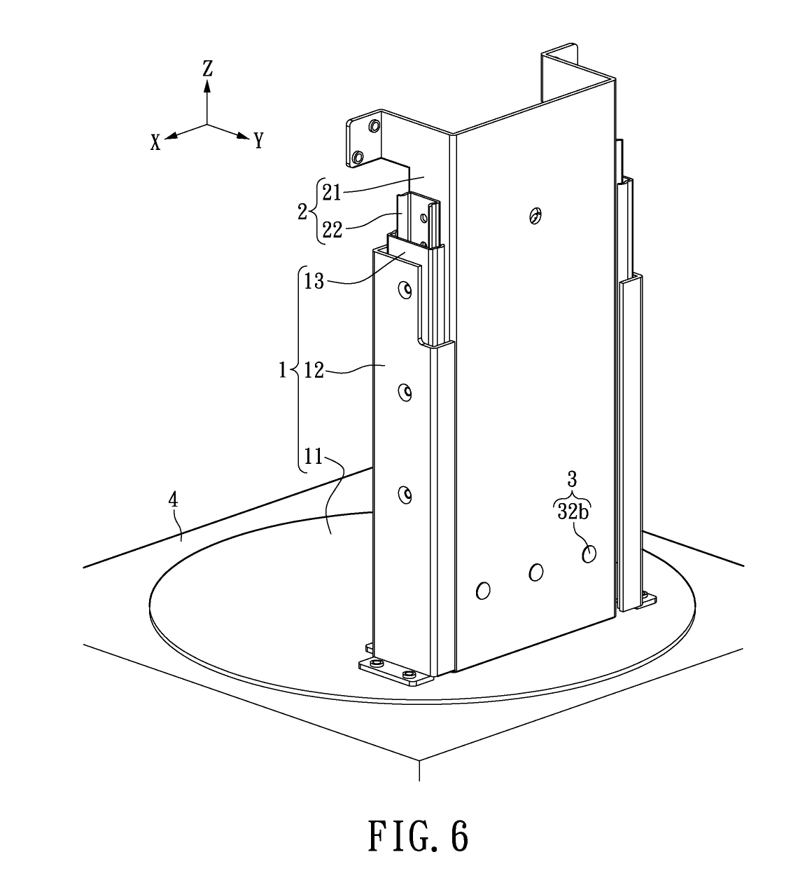

When the frame 21 of the sliding mechanism 2 is adjusted from its highest position (as shown in FIG. 4) to the lowest position (as shown in FIG. 6), the force member 32 of each counter force-generating mechanism 3 is urged to move accordingly through the corresponding locking stud 32b.

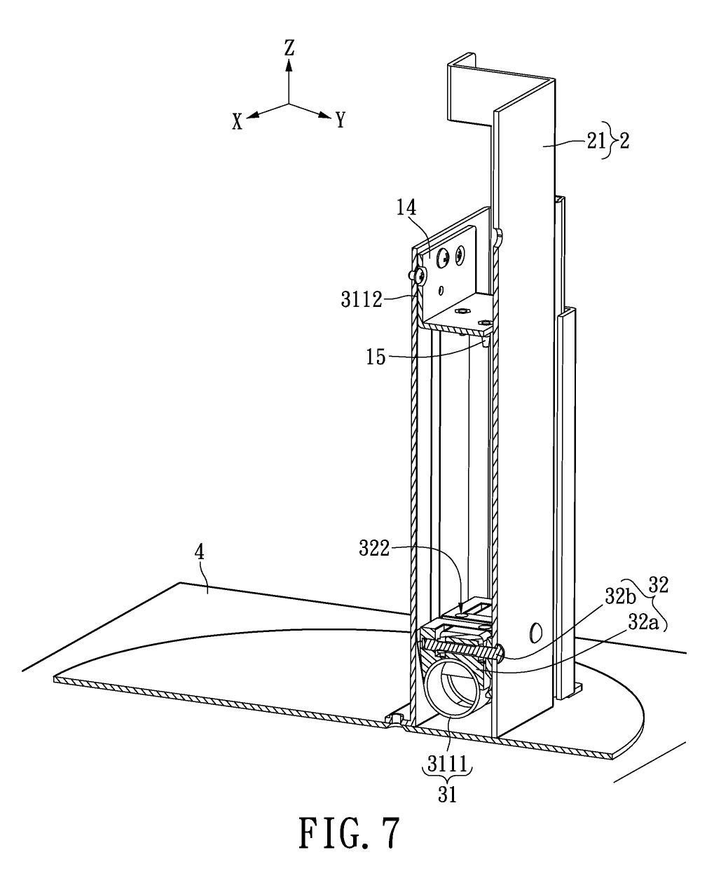

More specifically, when the frame 21 of the sliding unit 2 is adjusted to the lowest position (i.e.: adjusting the frame 21 of the sliding unit 2 from the highest position shown in FIG. 4 to the lowest position shown in FIG. 6), the state of the counter force-generating mechanism 3 is shown in FIG. 7. The applied force in moving the frame 21 of the sliding unit 2 is transferred to the main portion 32a of each force member 32 through the corresponding locking stud 32b. This transferred force enables the main portion 32a to disengage away from the corresponding retaining member 15, as the main portion 32a and the frame 21 of the sliding mechanism 2 jointly move downward. While moving downward, the rolled portion 3111 of each constant-force spring 311 is pressed against by the corresponding main portion 32a. The pressing force unrolls the rolled portion 3111, where the constant-force spring 311 is changed from its relaxed state (fully rolled up) to an extended state (partially straightened).

The length of the straightened segment of the rolled portion 3111 is approximately the same as the distance travelled by the frame 21 of the sliding mechanism 2. In other words, the respective distance travelled by the frame 21 of the sliding unit 2 and the counter force-generating mechanisms 3 with respect to the working surface 4 are substantially the same.

When the frame 21 of the sliding mechanism 2 is changing its position, regardless the length of the straightened segment of the rolled portion 3111, a substantially constant counter force is provided by the constant-force spring 311 directed in an upward direction. The counter force is approximately the same as the total weight of the sliding unit 2 and its supported article (monitor). The sliding unit 2 and its supported article may be selectively stopped at any position along the tracks 13.

Furthermore, the counter forces between respective constant-force springs 311 do not need to be identical. Depending on the total weight of the sliding unit 2 and supported article, the user may change the number of counter force-generating mechanisms 3 that are engaged to the sliding mechanism 2 (i.e.: some counter force-generating mechanisms 3 may remain unengaged). Thus, the sliding unit 2 and the supported article may be stopped arbitrarily along the tracks 13.

For example, the counter forces for a constant-force spring A, a constant-force spring B, and a constant-force spring C are 1 unit, 2 units, and 4 units, respectively. The table below shows the possible combination in using the springs.

| | Total Counter |
|---|---|
| Spring (s) | Force |
| Constant-Force Spring A | 1 |
| Constant-Force Spring B | 2 |
| Constant-Force Spring C | 4 |
| Constant-Force Spring A + B | 3 |
| Constant-Force Spring A + C | 5 |
| Constant-Force Spring B + C | 6 |
| Constant-Force Spring A + B + C | 7 |
| None | 0 |

In other words, seven possible scenarios are presented, with each scenario having a particular total counter force exerted by the spring (s). When no spring is utilized, as shown in FIGS. 1˜3, the total counter force is zero.

Alternatively, one of the force members 32 may be permanently connected to the sliding mechanism 2. For example, after the locking stud 32b has penetrated the penetrating hole 2111, the securing hole 2311, the side holes 331 of the coupler 33, the center hole 324 of the main portion 32a, and into the blind hole 325 in sequence, the locking stud 32b is welded to the sliding mechanism 2. Thus, the sliding mechanism 2 now has an inherent counter force.

### Second Embodiment

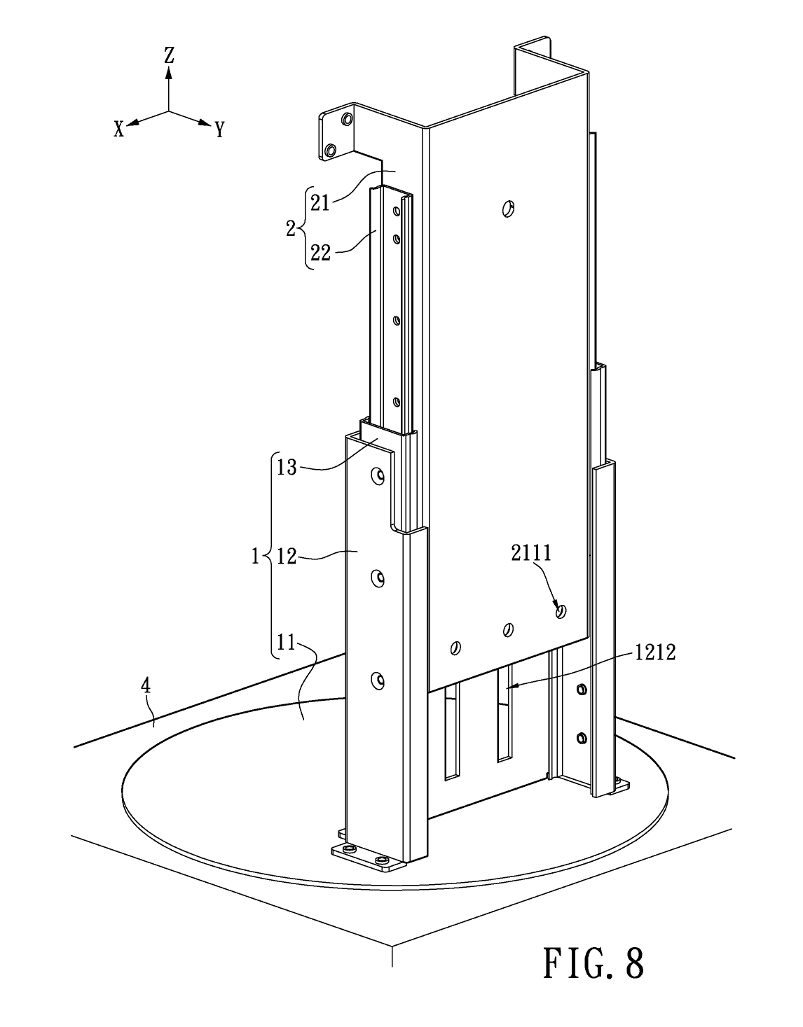

Please refer to FIGS. 8˜10, which show a second embodiment of the instant disclosure. The instant embodiment is similar to the previous embodiment, where the same description is not repeated herein. The main difference being for the instant embodiment, the aforementioned constant-force spring is replaced by a tension spring. Furthermore, the instant embodiment is without the divider 23. The counter force-generating mechanism 3 and the components connected thereto also vary from the previous embodiment. The abovementioned differences are discussed in detail hereinbelow.

The description that follows immediately is with regard to when the counter force-generating mechanisms 3 are disconnected from the sliding mechanism 2, and where the frame 21 is oriented at the highest position.

In a direction parallel to the first direction Z, the main plate 121 of the support 12 further defines a plurality of elongated guide slots 1212 (only two guide slots can be seen in the figures). For the instant embodiment, the number of guide slots 1212 is three, and each of the guide slots 1212 is spaced apart from each other. The stopping member 14 is accommodated by the receiving space 123. The stopping member 14 includes the rest plate 141, the stop plate 142 normally extended from one side of the rest plate 141, and a plurality of L-shaped arms 143 protruding from an edge portion of the stop plate 142 and being spaced apart from each other.

Fasteners (not shown), such as screws, are utilized to pass through the via holes 1411 of the rest plate 141 and the fastening holes 1211 of the support 12, for fixing the stopping member 14 to an inner surface of the main plate 121 of the support 12 that defines the receiving space 123.

The stand of the instant embodiment also utilizes three counter force-generating mechanisms 3. Each counter force-generating mechanism 3 includes the spring 31, the force member 32, and the coupler 33. Since all three counter force-generating mechanisms 3 have the same structural features, the description provided hereinbelow describes one of the counter force-generating mechanisms 3 in detail.

The spring 31 used in the instant embodiment is particularly a tension spring, which is represented by the numeral 312. The tension spring 312 is disposed in the receiving space 123, where the tension spring 312 has a main body 3121 and a pair of raised hooks 3122 extending from opposite ends thereof. The main body 3121 is arranged between the stop plate 142 and the base plate 11. One of the raised hooks 3122 is hung on the corresponding arm 143 of the stopping member 14.

For the instant embodiment, the main portion 32a of the force member 32 is substantially cylindrical-shaped. The main portion 32a is divided into a first sub-portion 326 and a second sub-portion 327 separated by the receiving structure 323 formed centrally on the main portion 32a. The second sub-portion 327 has a greater diameter than the first sub-portion 326. The retaining hole 322 is formed on an end portion of the first sub-portion 326 facing away from the second sub-portion 327. The end portion of the second sub-portion 327 facing away from the first sub-portion 326 defines the blind hole 325.

The first sub-portion 326 has a non-circular cross-section, where the smallest width of the first sub-portion 326 is substantially the same as the width (not labeled) of the guide slot 1212 in the direction parallel to the third direction X. The first sub-portion 326 is inserted into the corresponding guide slot 1212. Whereas the blind hole 325 is aligned axially to the corresponding penetrating hole 2111 of the frame 21. The other raised hook 3122 of the tension spring 312 is hung on the receiving structure 323 of the main portion 32a.

The coupler 33 has a fastening plate 332 and a protrusion 333 extended therefrom. The side hole 331 is formed through the fastening plate 332 and the protrusion 333. The side hole 331 is shaped matchingly to the first sub-portion 326.

For the portion of the side hole 331 formed on the protrusion 333, the first sub-portion 326 is received therein. The fastening plate 332 is abutted to the outer surface of the main plate 121 of the support 12. Screws (not labeled) are passed through the side holes 331 of the coupler 33 and the retaining holes 322 of the main portions 32a. Thus, the coupler 33 and the main portions 32a are paired to move jointly along the corresponding guide slot 1212.

Based on the above, the counter force-generating mechanisms 3 of the instant embodiment shown in FIGS. 8˜10 are not connected by any means to the sliding mechanism 2. In other words, the tension springs 312 of the counter force-generating mechanisms 3 are not exposed to applied loads from the sliding mechanism 2 and the mounted article (e.g., monitor).

Thereby, when the frame 21 of the sliding mechanism 2 is adjusted from the highest to the lowest positions while under the exerted force, the counter force-generating mechanisms 3 remain at the same position. In other words, the distance between the counter force-generating mechanisms 3 and the working surface 4 remains constant.

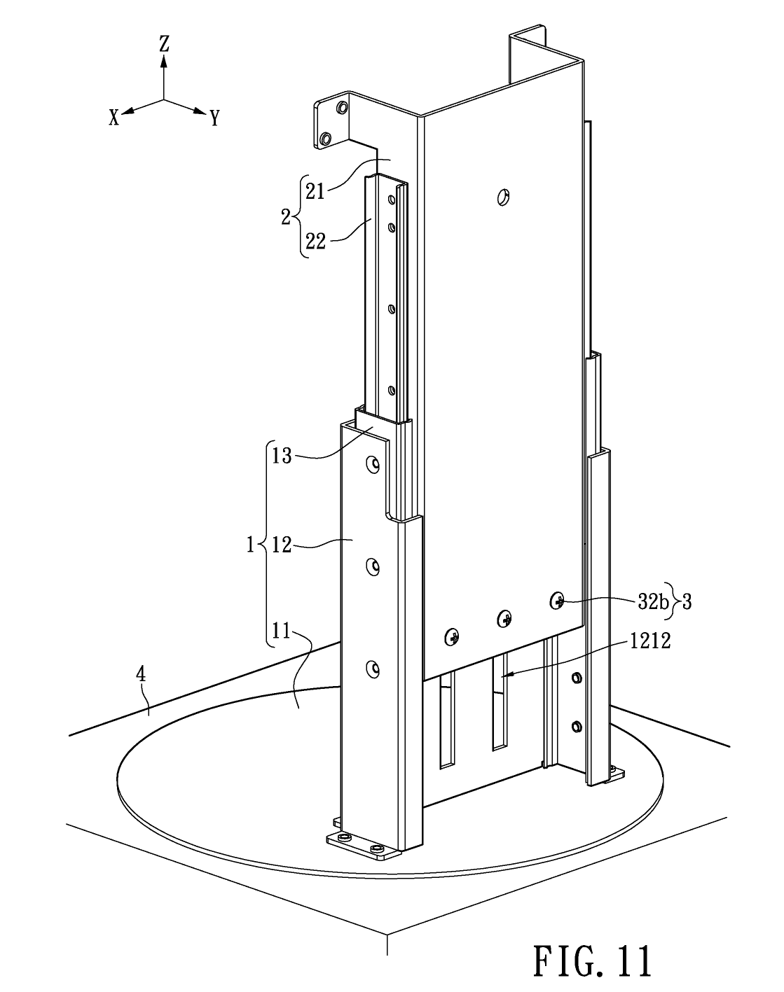

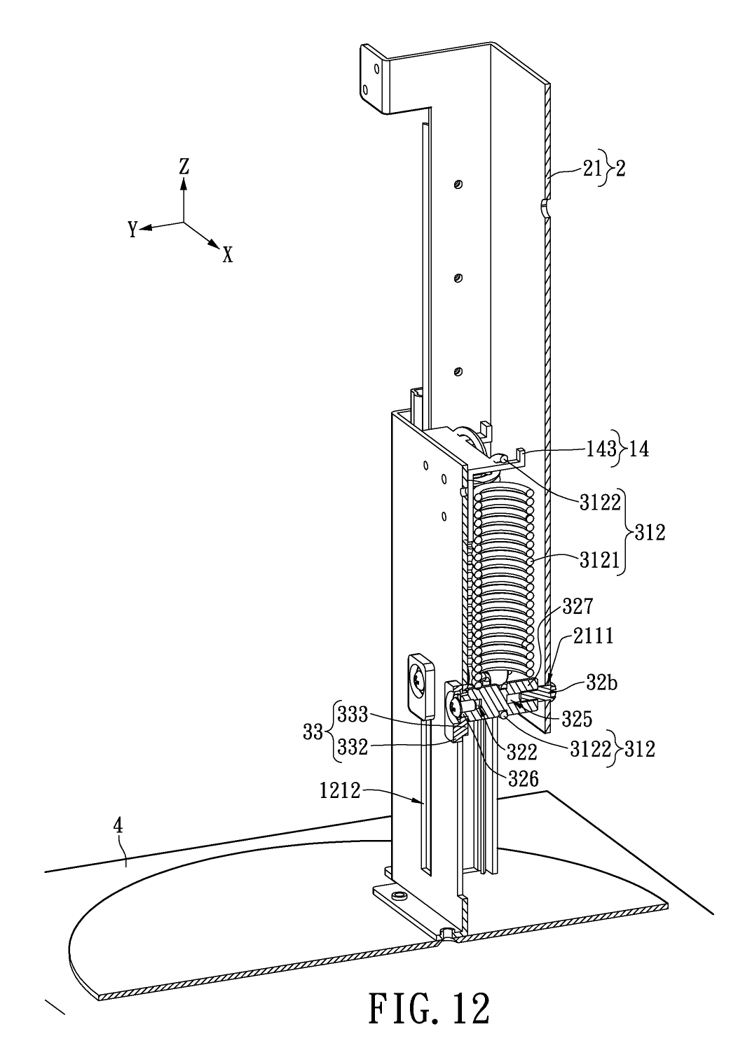

Now refer to FIGS. 11 and 12, which show the state where the counter force-generating mechanisms 3 are engaged to the sliding mechanism 2. Again, the description that follows immediately is for the state when the frame 21 of the sliding mechanism 2 is arranged at the highest position.

For the three force members 32, each force member 32 further includes one locking stud 32b. For the instant embodiment, a screw is utilized as the locking stud 32b. The locking stud 32b is passed through the corresponding penetrating hole 2221 of the frame 21 and the blind hole 325 of the main portion 32a, along a direction parallel to the second direction Y.

Other than the screw, the locking stud 32b may take on other form. For example, the locking stud 32b may be a button (not shown). The user can press the locking stud 32b to connect the corresponding counter force-generating mechanism 3 to the sliding mechanism 2.

Therefore, by utilizing the locking stud 32b, the corresponding counter force-generating mechanism 3 of the instant embodiment can be connected to the sliding mechanism 2. The connection allows the tension springs 312 to bear the loads, which are the sliding mechanism 2 and the mounted article (e.g., the monitor).

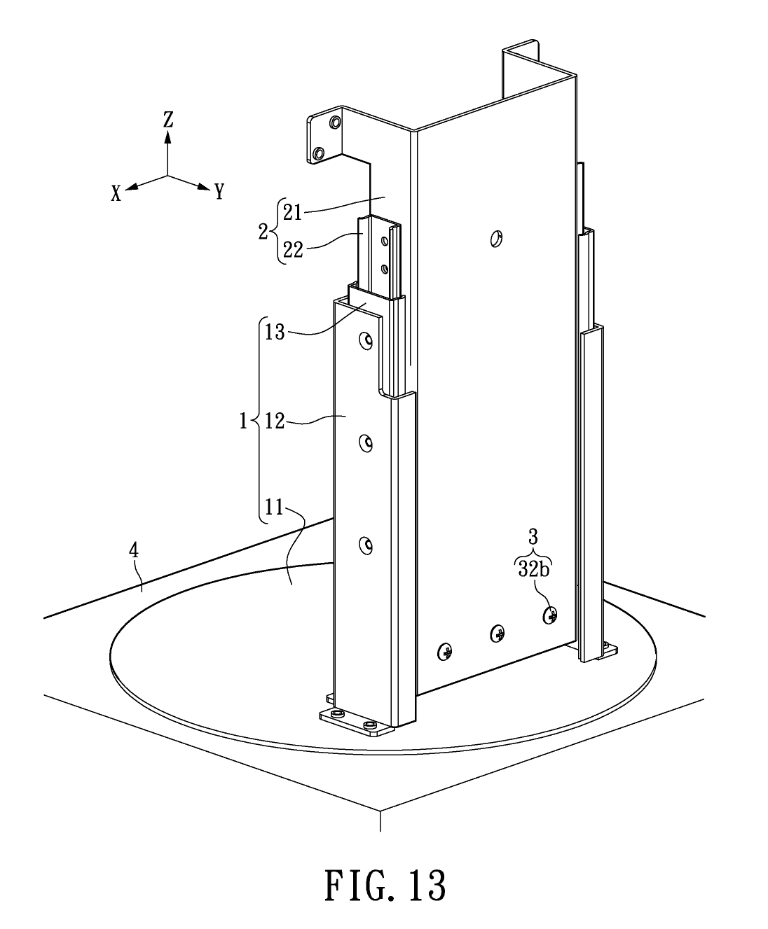

When the frame 21 of the sliding mechanism 2 is adjusted from the highest position (FIG. 11) to the lowest position (FIG. 13), the counter force-generating mechanisms 3 are moved accordingly through the respective locking studs 32b.

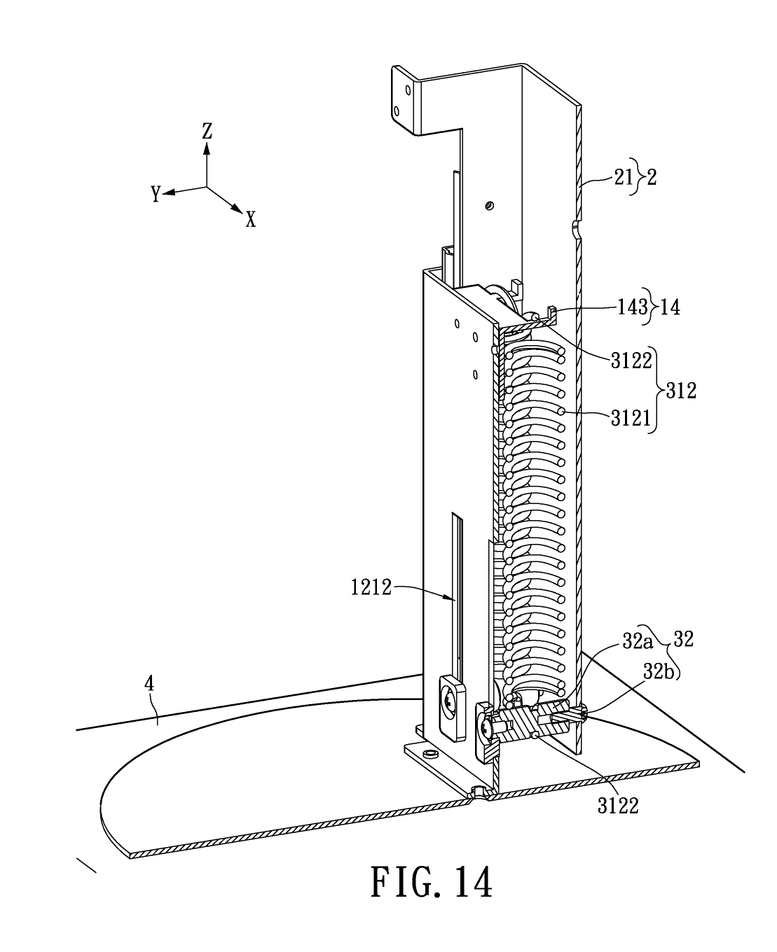

More specifically, when the frame 21 of the sliding mechanism 2 is moving toward the lowest position (i.e.: the frame 21 is adjusted from the position shown in FIG. 11 to the position shown in FIG. 13), the applied force to the frame 21 is transferred to each main portion 32a through the corresponding locking stud 32b (as shown in FIG. 14). The main portion 32a stretches the corresponding tension spring 312 and moves along with the frame 21 downwardly. The main body 3121 of the tension spring 312 is stretched by the applied force.

The stretching length is approximately the same as the distance travelled by the frame 21. In other words, the respective distances travelled by the frame 21 and the counter force-generating mechanisms 3 with respect to the working surface 4 are substantially the same.

The description provided thus far is for describing the frame 21 of the sliding mechanism 2 oriented at the highest and lowest positions. However, in practice, the counter force provided by each tension spring 312 directed upwardly varies according to the stretching distance of the corresponding tension spring 312. In other words, the allowable range where the frame 21 and its mounted article (e.g., monitor) may stop arbitrarily along the tracks 13 is probably more restricted.

For example, the sliding mechanism 2 and the mounted article have a total weight W, and the tension springs 312 have a total counter force F. The maximum frictional force of the stand is f. When W+f□F□W−f, the sliding mechanism 2 and the mounted article may be stopped arbitrarily. However, for the instant embodiment, the allowable height adjustment may be more restricted relative to the previous embodiment.

Like the previous embodiment, the counter force provided by each tension spring 312 may be different. The locking studs 32b may be utilized to establish different spring combinations.

Thus, when the stand is being stored or transported, the counter force-generating mechanisms 3 are not connected to the sliding mechanism 2. When the frame 21 of the sliding mechanism 2 is adjusted to the lowest position to minimize the occupied space by the stand, the springs 31 of the counter force-generating mechanisms 3 remain unstretched. Thus, elastic fatigue can be prevented.

Furthermore, based on the total weight of the sliding mechanism 2 and the mounted article, an appropriate number of counter force-generating mechanisms 3 may be connected to the sliding mechanism 2, while other counter force-generating mechanisms 3 remain unconnected. Thus, the frame 21 and the mounted article may be adjusted to a desired elevation according to the user.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A height-adjustable stand for providing support and position control of a monitor and disposing on a working surface, comprising:
a base arranged on the working surface;
a frame slidably disposed on the base;
a plurality of springs, one end of each spring fixed to the base; and
a plurality of force members selectively connected to the respective springs, each force member being selectively engageable to the frame,
wherein when the frame slides with respect to the base, the engaged force member moves with the frame, while a counter force is generated by the corresponding spring for maintaining the frame in any position between a first position and a second position.

2. The stand of claim 1, wherein the base includes a support and a stopping member fixedly disposed thereon, wherein the frame is slidably disposed on the support and the stopping member is capable of blocking the force members.

3. The stand of claim 1, wherein each spring is a constant-force spring having a rolled portion and a tip portion, wherein the rolled portion is abutted to the corresponding force member and the tip portion is fixed to the base.

4. The stand of claim 3, wherein each force member has a main portion having a receiving structure formed thereon for accommodating the rolled portion of the corresponding constant-force spring.

5. The stand of claim 2, wherein each force member has at least one retaining hole formed thereon, and wherein the stopping member includes at least one retaining member for inserting through the retaining hole.

6. The stand of claim 2, wherein each spring is a tension spring having a main body and a pair of raised hooks extending from opposite ends thereof, and wherein the respective raised hooks of each tension spring are fixed to the stopping member and the corresponding force member.

7. The stand of claim 6, wherein the stopping member has a plurality of arms, wherein each force member has a main portion having a receiving structure, and wherein the respective raised hooks of each tension spring are fixed to the receiving structure of the corresponding force member and the corresponding arm of the stopping member.

8. The stand of claim 7, wherein the support has a plurality of elongated guide slots formed thereon, wherein the long axis of each guide slot is parallel to the stretching direction of the tension springs, wherein a coupler is disposed on the main portion of each force member, and wherein the main portion of each force member and the corresponding coupler are movably disposed on the support and capable of riding along the respective guide slot.

9. The stand of claim 1, wherein each force member engaged to the frame includes a locking stud removably connected to the frame.

10. The stand of claim 1, wherein one of the force members is connected to the corresponding spring and permanently connected to the frame.
